(19) United States
(12) Patent Application Publication
(10) Pub. No.: US 2008/0122627 A1
(43) Pub. Date: May 29, 2008

(54) METHOD AND APPARATUS FOR READING RADIO FREQUENCY IDENTIFICATION TAGS

(75) Inventors: Yun-Shen Chang, Chiayi County (TW); Ya-Ping Chen, Kaohsiung County (TW); Jiunn-Tsair Chen, Hsinchu City (TW); Ze-Yao Chang, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/674,677

(22) Filed: Feb. 14, 2007

(30) Foreign Application Priority Data
Nov. 29, 2006 (TW) 95144169

(51) Int. Cl. G08B 13/14

(52) U.S. Cl. 340/572.7

(57) ABSTRACT

A method and an apparatus for reading radio frequency identification (RFID) tags are provided. First, an omni-directional radio frequency signal is emitted out to omni-directionally scan RFID tags. Then, a radio frequency signal composed of P beams is emitted directed to P specific directions, and a spatial matched filter processing is performed to read the RFID tags in P specific directions, wherein P is an integer larger than or equal to 1. In order to scan all the directions, the method adjusts angles of P specific directions and repeats the steps of emitting beams and filtering, and thereby reading the RFID tags in all the directions. Therefore, the method and apparatus of the present invention can simultaneously read a plurality of RFID tags and enlarge the scan range and effective read rate without increasing the transmit power.

### CROSS-REFERENCE TO RELATED APPLICATION

This application claims the priority benefit of Taiwan application serial no. 95144169, filed on Nov. 29, 2006. All disclosure of the Taiwan application is incorporated herein by reference.

### BACKGROUND OF THE INVENTION

1. Field of the Invention

The present invention relates to radio frequency identification (RFID) technology, and more particularly, to a method and an apparatus for reading radio frequency identification (RFID) tags.

2. Description of Related Art

Recently, the radio frequency identification (RFID) technology has advantages in contactless identification and data safety, so it has gradually replaced the existing bar code technology and has been widely applied in various fields, for example, smart cards, electronic fare payment, anti-theft in stores and animal identification ICs. In practice, the RFID technology mainly utilizes an apparatus referred as reader to emit a radio frequency signal, and to receive a radio frequency signal reflected by the RFID tag, and meanwhile determines whether the radio frequency signal reflected by the RFID tag is correct or not.

To cater to the application demanding in various fields, the current RFID technology has gradually developed towards a trend of large memory capacity, long distance, and simultaneously detecting a plurality of RFID tags. However, in actual applications, since the conventional reading apparatus only utilizes a single antenna to send and receive radio frequency signals, it can only receive a signal sent back by one RFID tag at one time point. Supposing the conventional reading apparatus detects more than two RFID tags at the same time, and due to the irregular arrangements of the RFID tags or the interference among signals, the conventional reading apparatus cannot read the signals sent back by the RFID tags, and thus the read rate of the conventional reading apparatus is reduced.

In other words, since the conventional reading apparatus has a very low read rate, the RFID technology cannot use a single conventional reading apparatus to simultaneously read a plurality of RFID tags. Therefore, in order to cater to the application demanding in various fields, the RFID technology must utilize a plurality of conventional reading apparatuses to achieve the function of reading a plurality of RFID tags simultaneously.

### SUMMARY OF THE INVENTION

The present invention is directed to providing a method for reading RFID tags, which detects the RFID tags by utilizing an omni-directional radio frequency signal and a radio frequency signal composed of beams, thereby increasing the read rate of a reading apparatus.

The present invention is directed to providing an apparatus for reading RFID tags, which scans the RFID tags in different specific directions by utilizing the beams with different intensities emitted by it, and thus the apparatus for reading RFID tags is capable of simultaneously reading a plurality of RFID tags.

The present invention provides a method for reading RFID tags, which comprises the following steps. First, an omni-directional radio frequency signal is emitted out to omni-directionally scan the RFID tags. Next, a radio frequency signal composed of P beams is emitted directed to P specific directions, wherein P is an integer larger than or equal to 1. Then, directed to P specific directions, a spatial matched filter processing is performed to read the RFID tags in P specific directions. In order to scan the RFID tags in all the directions, the reading method adjusts the angles of P specific directions, and repeats the above steps of emitting beams and filtering, so as to read the RFID tags in all the directions.

In the other aspect, the present invention provides an apparatus for reading RFID tags, which comprises an antenna array and a beam synthesis unit, wherein the antenna array comprises a plurality of antennas; and the beam synthesis unit comprises a plurality of weight control units coupled to the corresponding antennas one by one. In the overall operations, the beam synthesis unit is used to adjust the weight vector of the antenna array, so as to form a beam or a null in a predetermined direction. Furthermore, the reading apparatus emits an omni-directional radio frequency signal to omni-directionally scan the RFID tags. Then, the reading apparatus emits a radio frequency signal composed of P beams directed to P specific directions, and a spatial matched filter processing is performed in P specific directions, so as to read the RFID tags in P specific directions, wherein P is an integer larger than or equal to 1.

Embodiments accompanied with figures of the present invention are described in detail below. It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an architecture view of an apparatus for reading RFID tags according to an embodiment of the present invention.

FIG. 2 is a flow chart of a method for reading RFID tags according to an embodiment of the present invention.

FIG. 3 is a beam pattern for illustrating the embodiment of FIG. 2.

FIG. 4 is a beam pattern for illustrating the embodiment of FIG. 3.

FIG. 5 is another beam pattern for illustrating the embodiment of FIG. 2.

FIG. 6 is a beam pattern for illustrating the embodiment of FIG. 5.

FIG. 7 is still another beam pattern for illustrating the embodiment of FIG. 2.

FIG. 8 is a beam pattern for illustrating the embodiment of FIG. 7.

FIG. 9 is another flow chart of the method for reading the RFID tags according to the embodiment of the present invention.

FIG. 10 is a beam pattern for illustrating the embodiment of FIG. 9.

FIG. 11 is another beam pattern for illustrating the embodiment of FIG. 9.

FIG. 12 is still another beam pattern for illustrating the embodiment of FIG. 9.

FIG. 13 is yet another beam pattern for illustrating the embodiment of FIG. 9.

### DESCRIPTION OF EMBODIMENTS

As embodied and broadly described herein, the present invention provides a method for reading RFID tags, which comprises the following steps. First, an omni-directional radio frequency signal is emitted out to omni-directionally scan the RFID tags. Next, a radio frequency signal composed of P beams is emitted directed to P specific directions, wherein P is an integer larger than or equal to 1. Then, directed to P specific directions, a spatial matched filter processing is performed to read the RFID tags in P specific directions. In order to scan the RFID tags in all the directions, the reading method adjusts the angles of P specific directions, and repeats the above steps of emitting beams and filtering, so as to read the RFID tags in all the directions.

In the method for reading RFID tags according to an embodiment of the present invention, it further comprises changing the number of P, and repeating all the other steps except emitting out an omni-directional radio frequency signal, so as to repeatedly read the RFID tags in all the directions.

It should be noted that, the method for reading RFID tags is applicable for a reading apparatus. The reading apparatus comprises a plurality of antennas and a plurality of weight control units corresponding to the antennas one by one, wherein the weight control units are used for adjusting weights of the corresponding antennas, so as to emit the beams or perform the spatial matched filter processing directed to the specific directions.

In the other aspect, the present invention provides an apparatus for reading RFID tags, which comprises an antenna array and a beam synthesis unit, wherein the antenna array comprises a plurality of antennas; and the beam synthesis unit comprises a plurality of weight control units coupled to the corresponding antennas one by one.

In the overall operations, the beam synthesis unit is used to adjust the weight vector of the antenna array, so as to form a beam or a null in a predetermined direction. Furthermore, the reading apparatus emits an omni-directional radio frequency signal to omni-directionally scan the RFID tags. Then, the reading apparatus emits a radio frequency signal composed of P beams directed to P specific directions, and a spatial matched filter processing is performed in P specific directions, so as to read the RFID tags in P specific directions, wherein P is an integer larger than or equal to 1.

In the apparatus for reading RFID tags according to an embodiment of the present invention, the reading apparatus adjusts angles of P specific directions, and repeatedly emits a radio frequency signal composed of P beams directed to P new specific directions. Then, in order to enable the adjusted radio frequency signal to read the RFID tags in all the directions, the reading apparatus performs a spatial matched filter processing in P new specific directions, till all the directions have been scanned.

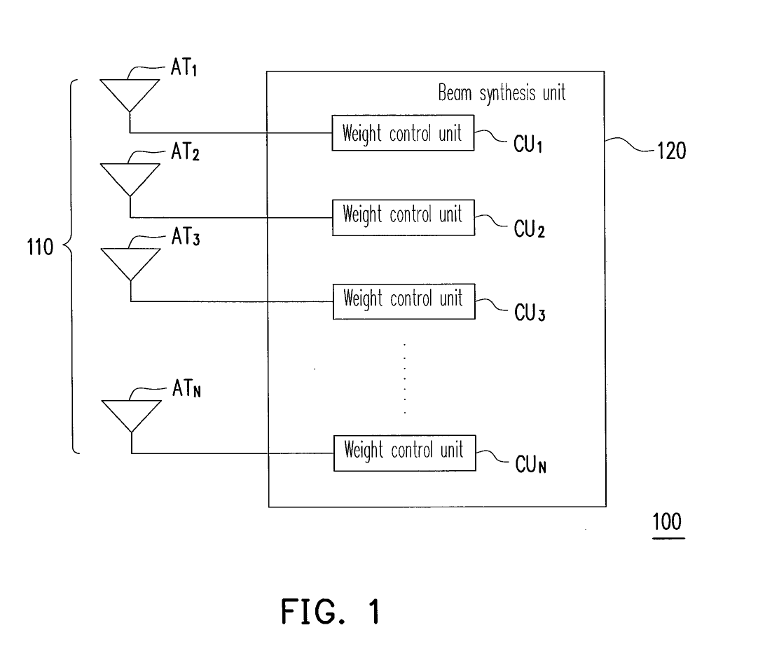

FIG. 1 is an architecture view of an apparatus for reading RFID tags according to an embodiment of the present invention. The reading apparatus 100 includes an antenna array 110 and a beam synthesis unit 120. The antenna array 110 includes antennas AT₁-AT_{N}, the beam synthesis unit 120 includes weight control units CU₁-CU_{N}, wherein N is an integer larger than 0. Additionally, the weight control units CU₁-CU_{N} are correspondingly coupled to the antennas AT₁-AT_{N} one by one. For example, the weight control unit CU₁ is coupled to the corresponding antenna AT₁, the weight control unit CU₂ is coupled to the corresponding antenna AT₂, and the coupling manner of the weight control units CU₃-CU_{N} can be deduced by analogy.

The weight vector of the antenna array 110 can be expressed as w=[w₁ w₂ w₃ . . . w_{N}]^{T}, wherein w₁-w_{N} are weights of the antennas AT₁-AT_{N}, [.]^{T} is an indicator of matrix transposition.

The reading apparatus 100 adjusts the weight vector of the antenna array 110 through the weight control units CU₁-CU_{N}, so as to form a beam or null in a predetermined direction. In the other aspect, the reading apparatus 100 emits a radio frequency signal composed of beams, so as to enlarge the range for reading the RFID tags. Furthermore, one antenna array 110 having N antennas AT₁-AT_{N} at most resolves (N−1) incident directions. In other words, the antenna array 110 is capable of performing a spatial matched filter processing simultaneously on signals sent back by at most (N−1) RFID tags. Therefore, under the circumstance of without considering noises, y indicates a vector of a signal output from the (N×1) antenna array 110, and the formula for the antenna array 110 to perform the spatial matched filter on a certain incident direction φᵢ is expressed as:

$$\begin{matrix}{w}^{H} ( {φ}_{i} ) y = {w}^{H} ( {φ}_{i} ) a ( {φ}_{i} ) {χ}_{{φ}_{i}} + {\sum }_{{j = 1}_{j \neq i}}^{N - 1} {w}^{H} ( {φ}_{i} ) a ( {φ}_{j} ) {χ}_{{φ}_{j}} \\ = {χ}_{{φ}_{i}} + {\sum }_{{j = 1}_{j \neq i}}^{N - 1} {w}^{H} ( {φ}_{i} ) a ( {φ}_{j} ) {χ}_{{φ}_{j}} ,\end{matrix}$$

wherein w(φᵢ) indicates a weight vector for matching with a(φᵢ) in the φᵢ direction, a(φᵢ) indicates a steering vector in the φᵢ direction, χ_{φ}_{ᵢ} indicates a signal sent back by the RFID tags at the φᵢ direction. Herein, the reading apparatus 100 utilizes the matching relationship between w(φᵢ) and a(φᵢ), and the characteristic of inhibiting other input signals, so as to obtain χ_{φ}_{ᵢ}.

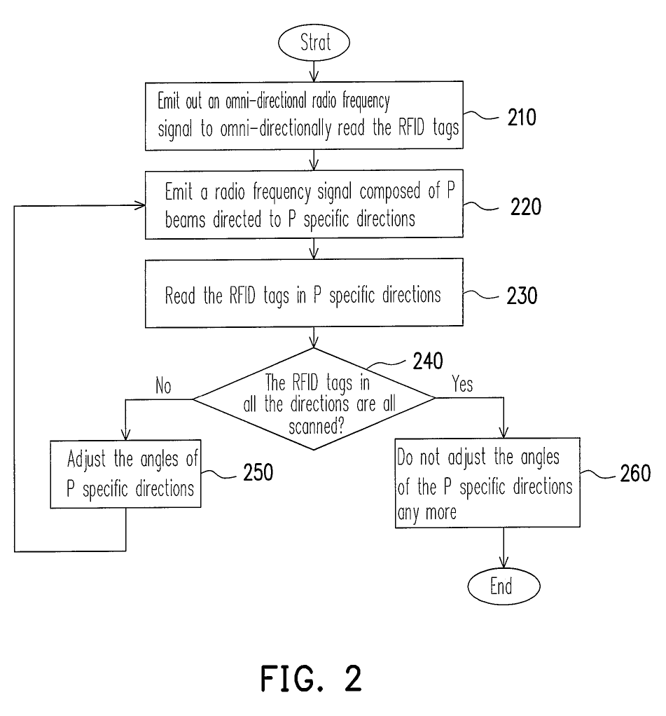

Next, the operation mechanism of this embodiment is illustrated with reference to FIG. 2, and FIG. 2 is a flow chart of a method for reading the RFID tags.

When detecting the RFID tags, the reading apparatus 100 scans the RFID tags through a plurality of stages. Referring to FIG. 2, first, the reading apparatus 100 emits out an omni-directional radio frequency signal to omni-directionally scan the RFID tags (step S210). Next, the reading apparatus 100 emits a radio frequency signal composed of P beams directed to P specific directions (step S220), and a spatial matched filter processing is performed directed to P specific directions, so as to read the RFID tags in P specific directions (step S230), wherein P is an integer larger than or equal to 1.

In order to scan the RFID tags in all the directions, the reading apparatus 100 determines whether to adjust angles of the P specific directions or not according to the determining result (step S240). If it is not scanned in any direction, the reading apparatus 100 adjusts the angles of P specific directions (step S250), and repeats steps S220-S240. Otherwise, the reading apparatus 100 stops adjusting the angles of the P specific directions (step S260).

It should be noted that, the power of the omni-directional radio frequency signal is the same as that of the radio frequency signal composed of P beams. In other words, the reading apparatus 100 utilizes a plurality of beams with different intensities to perform scanning in various specific directions. Directed to this view point, the operation mechanism of this embodiment is illustrated through a plurality of beam patterns, but which are not intended to restrict the present invention.

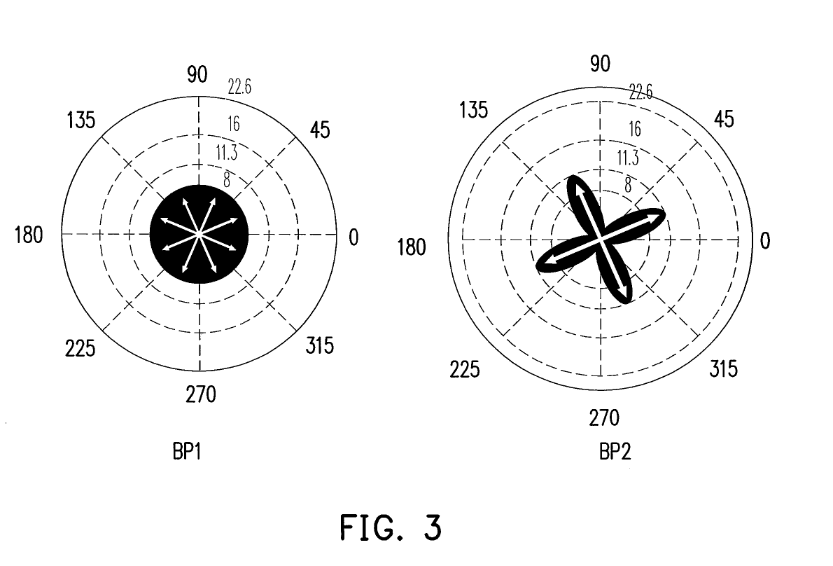

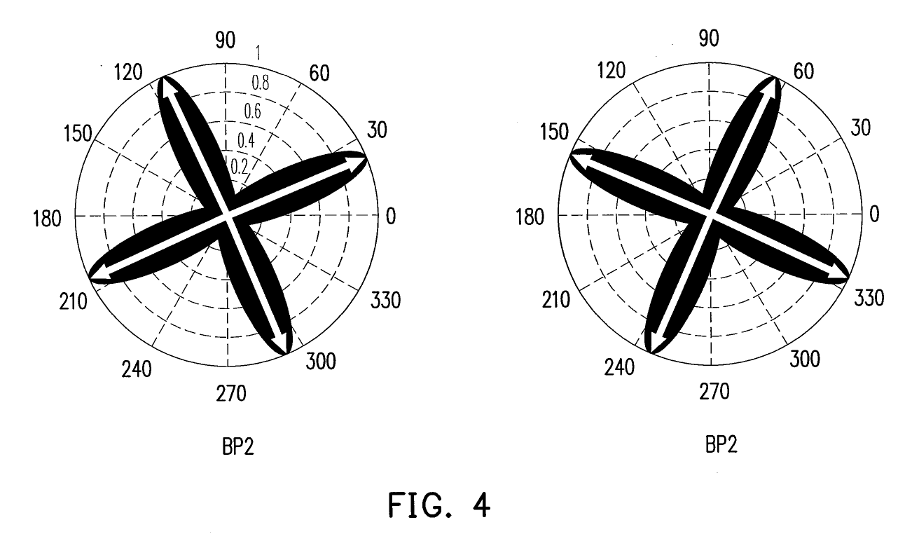

First, the beam pattern in FIG. 3 is taken as an example. The reading apparatus 100 emits out an omni-directional radio frequency signal BP1 to omni-directionally scan the RFID tags. At this point, as for the radio frequency signal emitted by the antenna array 110, the maximum distance for detecting the RFID tags varies depending upon the maximum tolerable emitting power. Next, the reading apparatus 100 emits a radio frequency signal BP2 composed of 4 beams directed to 4 specific directions, and the difference between each of the specific directions is 90 degrees. Therefore, as shown in FIG. 4, the reading apparatus 100 must emit the radio frequency signal BP2 composed of 4 beams twice, so as to read the RFID tags in all the directions.

It should be noted that, the power of the radio frequency signal BP2 composed of 4 beams is the same as that of the omni-directional radio frequency signal BP1. In other words, the power of each of the above beams is twice of that of the omni-directional radio frequency signal, and the maximum distance for detecting the RFID tags is \sqrt{2} times of that of the omni-directional radio frequency signal BP1. Therefore, the reading apparatus 100 can enlarge the detecting range of the RFID tags without increasing the total emitting power, and it can achieve the function of simultaneously reading a plurality of RFID tags.

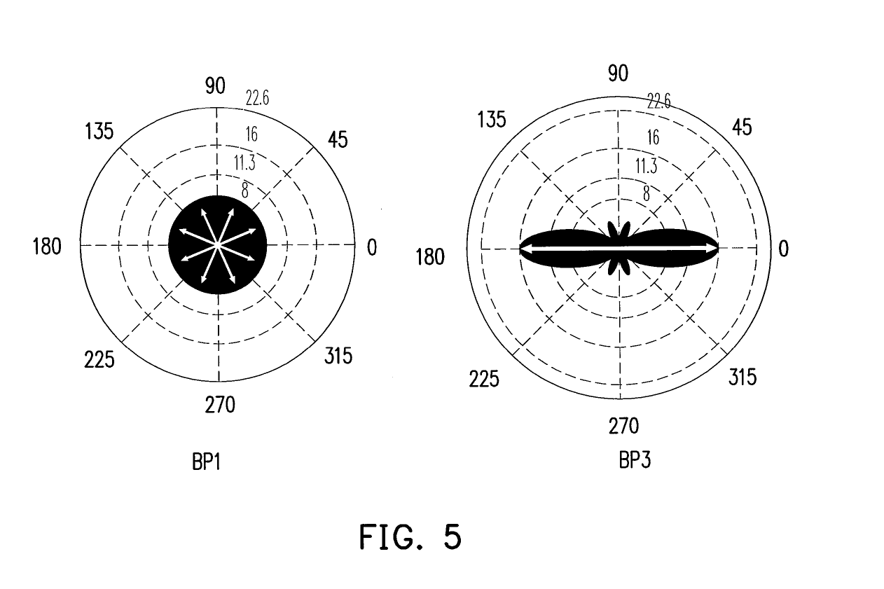

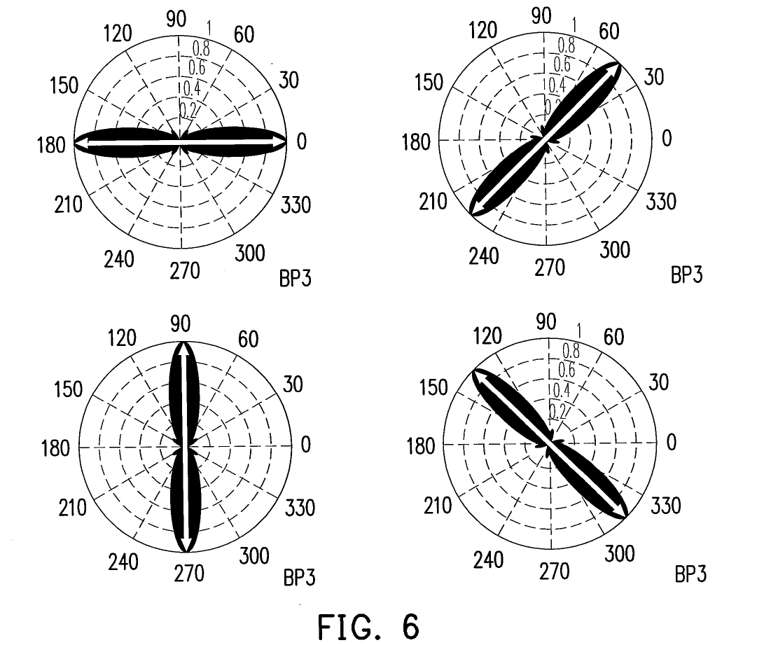

Then, the beam pattern in FIG. 5 is taken as an example. First, the reading apparatus 100 also utilizes the omni-directional radio frequency signal BP1 to read scan the RFID tags. Then, the reading apparatus 100 emits a radio frequency signal BP3 composed of 2 beams directed to 2 specific directions, wherein the difference between each of the specific directions is 180 degrees. Therefore, as shown in FIG. 6, the reading apparatus 100 must emit the radio frequency signal BP3 composed of 2 beams for 4 times, so as to read the RFID tags in all the directions.

It should be noted that, the power of the radio frequency signal BP3 composed of 2 beams is the same as that of the omni-directional radio frequency signal BP1. In other words, the power of each of the above beams is 4 times of that of the omni-directional radio frequency signal BP1, and the maximum distance for detecting the RFID tags is twice of that of the omni-directional radio frequency signal BP1.

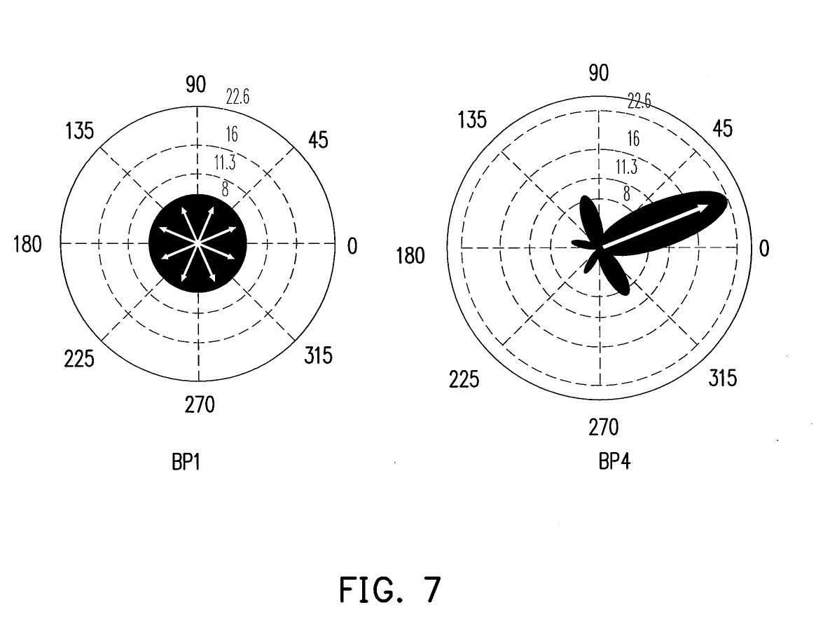

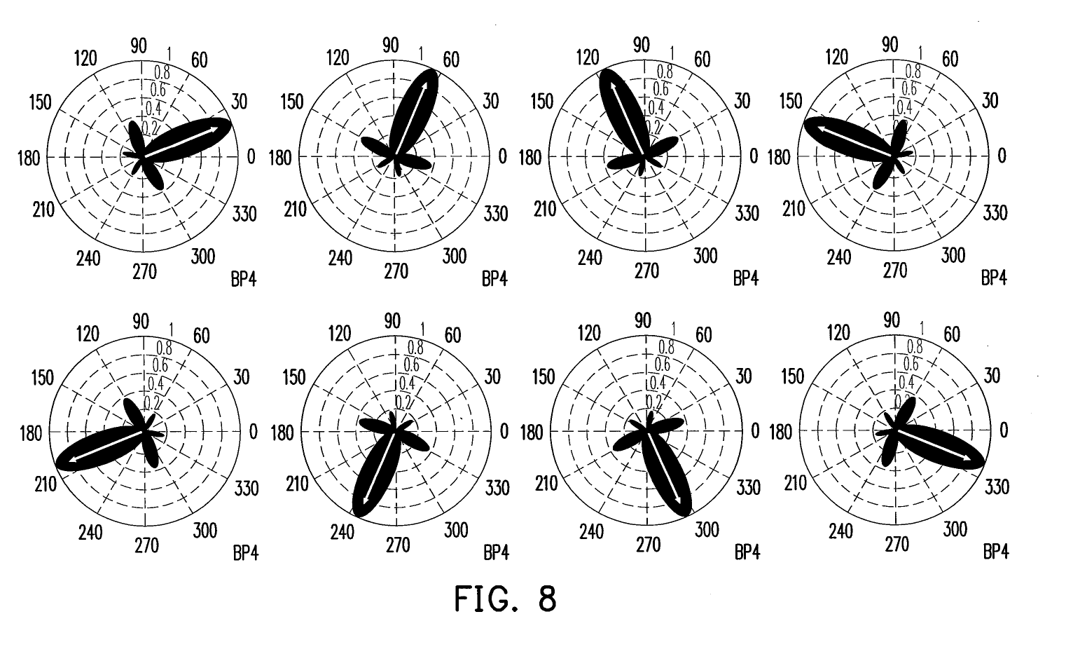

Then, the beam pattern of FIG. 7 is taken as an example. First, the reading apparatus 100 also utilizes the omni-directional radio frequency signal BP1 to read scan the RFID tags. Then, the reading apparatus 100 emits a radio frequency signal BP4 composed of 1 beam directed to 1 specific direction. Therefore, as shown in FIG. 8, the reading apparatus 100 must emit the radio frequency signal BP4 composed of 1 beam for 8 times, so as to read the RFID tags in all the directions.

It should be noted that, the power of the radio frequency signal BP4 composed of 1 beam is the same as that of the omni-directional radio frequency signal BP1. In other words, the power of each beam is 8 times of that of the omni-directional radio frequency signal BP1, and the maximum distance for detecting the RFID tag is 2\sqrt{2} times of that of the omni-directional radio frequency signal BP1.

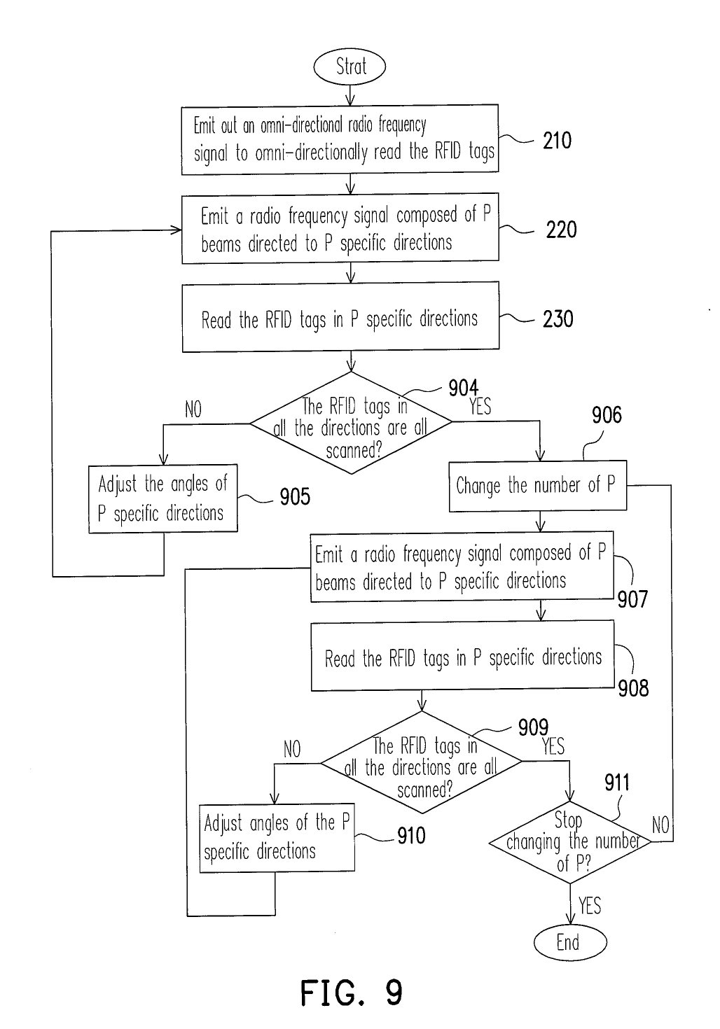

In the other aspect, FIG. 9 is another flow chart of the method for reading the RFID tags according to an embodiment of the present invention. The reading method disclosed in the embodiment of FIG. 9 is substantially the same as that of the embodiment of FIG. 2 in the following steps. An omni-directional radio frequency signal is emitted out to omni-directionally scan the RFID tags (step S901). Then, a radio frequency signal composed of P beams is emitted directed to P specific directions (step S902), so as to read the RFID tags in P specific directions (step S903). Furthermore, it is determined whether all the directions have been scanned (step S904), so as to adjust the angles of the P specific directions according to the determining result (step S905), and the above steps of S902-S905 are repeated till all the directions have been scanned.

However, the largest difference between the embodiment of FIG. 9 and the embodiment of FIG. 2 lies in that, if the determining result in step S904 is that the scanning has been performed in all the directions, the reading apparatus 100 changes the number of P, and performs steps S907-S910 (repeats steps S902-S905), until it stops changing the number of P according to the determining result of step S911. In order to make this embodiment more comprehensible to those skilled in the art, a plurality of beam patterns is taken as examples for illustrating the flow chart of the embodiment of FIG. 9, but which are not intended to limit the present invention.

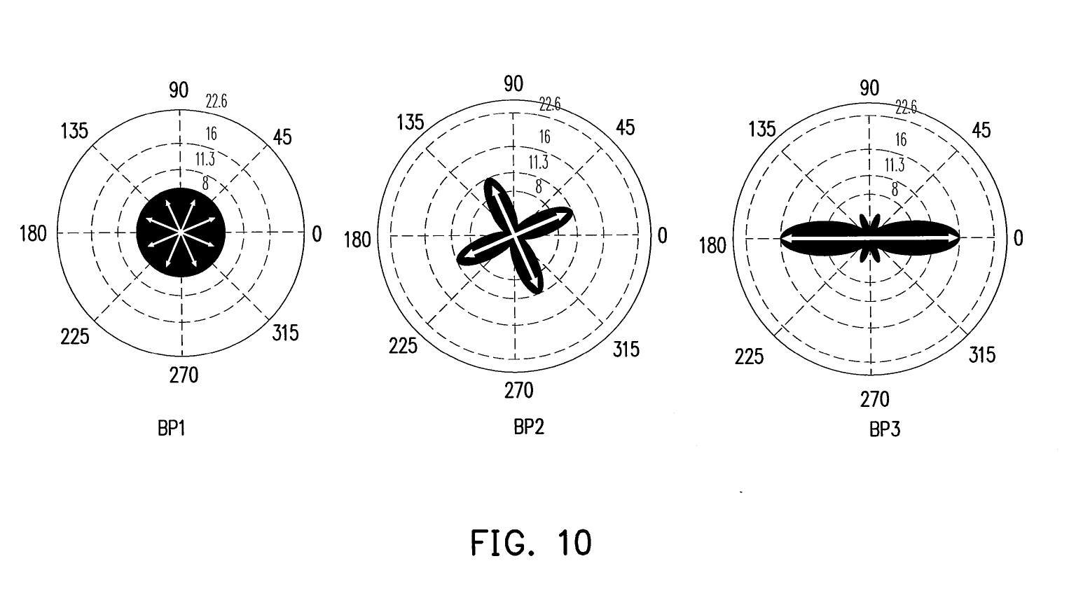

The beam pattern in FIG. 10 is taken as an example. After the reading apparatus 100 emits the omni-directional radio frequency signal BP1 and the radio frequency signal BP2 composed of 4 beams (the detailed steps can be obtained with reference to the embodiment of FIG. 3) according to steps S901-S905, the reading apparatus 100 adjusts P to 2 (step S906), so as to generate the radio frequency signal BP3 composed of 2 beams. In order make the adjusted radio frequency signal BP3 to read the RFID tags in all the directions, the reading apparatus 100 emits the radio frequency signal BP3 composed of 2 beams for 4 times through steps S907-S910 (as shown in FIG. 6). Finally, the reading apparatus 100 stops changing the number of P according to the determining result of step S911, and thereby completing the whole reading flow.

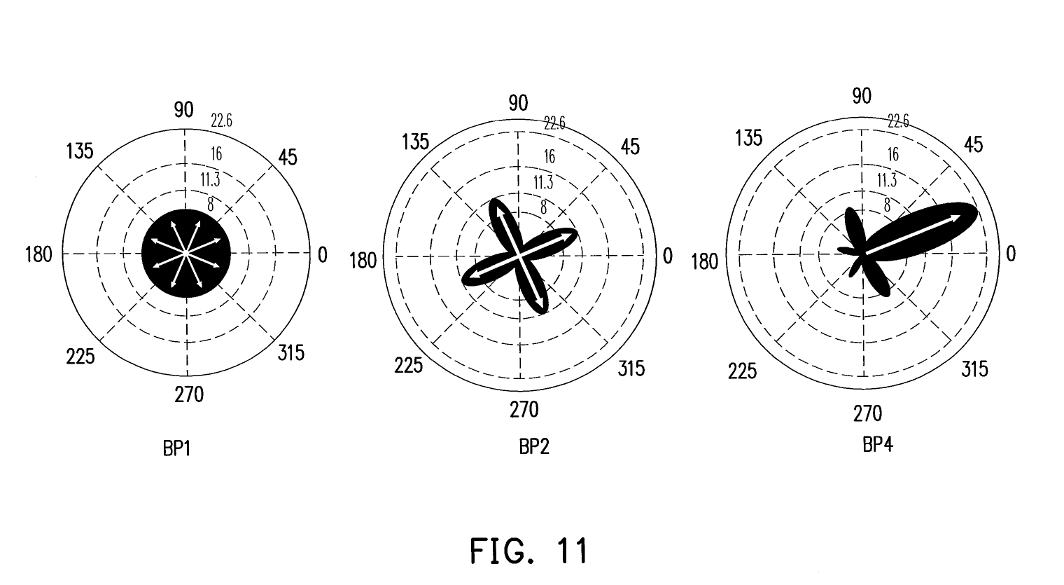

Similarly, the beam pattern in FIG. 11 is taken as an example. After the reading apparatus 100 emits the omni-directional radio frequency signal BP1 and the radio frequency signal BP2 composed of 4 beams (the detailed steps can be obtained with reference to FIG. 3) according to steps S901-S905, the reading apparatus 100 adjusts P to 1 (step S906), so as to generate the radio frequency signal BP4 composed of 1 beam.

At this point, in order to make the adjusted radio frequency signal BP4 to read the RFID tags in all the directions, the reading apparatus 100 emits the radio frequency signal BP4 composed of 1 beam for 8 times through steps S907-S910 (as shown in FIG. 8). Finally, the reading apparatus 100 stops changing the number of P according to the determining results in step S911, and thereby completing the whole reading flow.

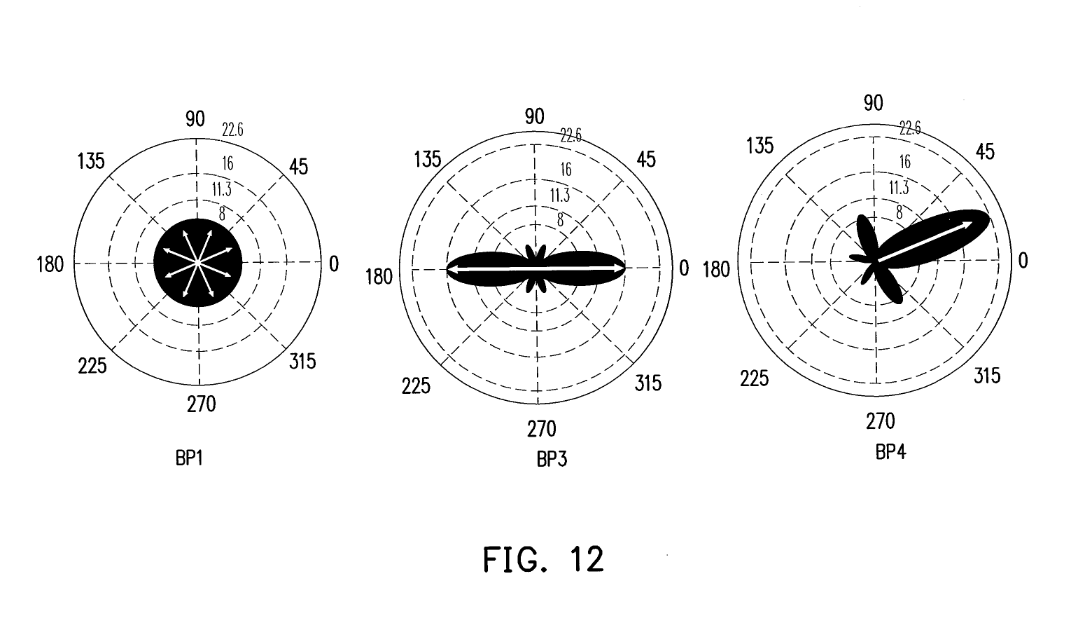

Then, the beam pattern of FIG. 12 is taken as an example. After the reading apparatus 100 emits the omni-directional radio frequency signal BP1 and the radio frequency signal BP3 composed of 2 beams (the detailed steps can be obtained with reference to FIG. 5) according to steps S901-S905, the reading apparatus 100 adjusts P to 1 (step S906), so as to generate the radio frequency signal BP4 composed of 1 beam.

At this point, in order to make the adjusted radio frequency signal BP4 to read the RFID tags in all the directions, the reading apparatus 100 emits the radio frequency signal BP4 composed of 1 beam for 8 times through steps S907-S910 (as shown in FIG. 8). Finally, the reading apparatus 100 stops changing the number of P according to the determining results in step S911, and thereby completing the whole reading flow.

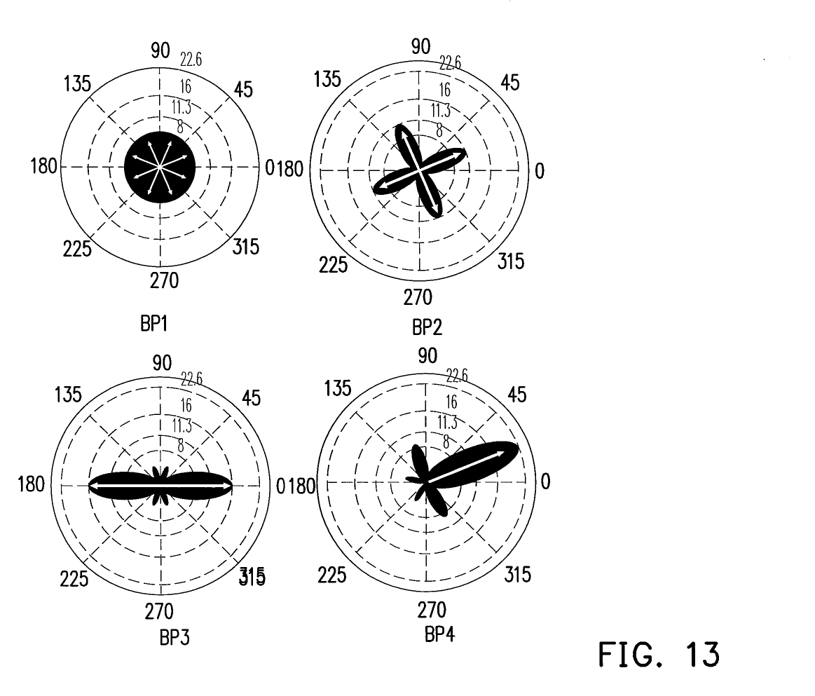

Finally, the beam pattern in FIG. 13 is taken as an example. Similarly, after the reading apparatus 100 emits the omni-directional radio frequency signal BP1 and the radio frequency signal BP2 composed of 4 beams (the detailed steps can be obtained with reference to the embodiment of FIG. 3) according to steps S901-S905, the reading apparatus 100 firstly adjusts P to 2 (step S906), so as to generate the radio frequency signal BP3 composed of 2 beams. Then, the reading apparatus 100 emits the radio frequency signal BP3 composed of 2 beams for 4 times through steps of S907-S910 (as shown in FIG. 6), so as to make the adjusted radio frequency signal BP3 to read the RFID tags in all the directions.

After the radio frequency signal BP3 has read the RFID tags in all the directions, the determining result in step S909 is continuously changing the number of P, and thus the reading apparatus 100 further adjusts P back to 1 (step S906), so as to generate the radio frequency signal BP4 composed of 1 beam. At this point, the reading apparatus 100 again emits the radio frequency signal BP3 composed of 1 beam for 8 times through the steps S907-S910 (as shown in FIG. 8), so as to make the adjusted radio frequency signal BP4 to read the RFID tags in all the directions.

After the radio frequency signal BP4 has read the RFID tags in all the directions, the determining result in step S909 is stop changing the number of P, and thus the reading apparatus 100 completes the whole reading flow.

To sum up, the present invention scans the RFID tags in various specific directions through emitting a plurality of beams with different intensities. Therefore, the reading apparatus is not only capable of simultaneously reading a plurality of RFID tags, but also effectively increasing the correct read rate, and enlarging the scan range without increasing the transmit power.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for reading radio frequency identification (RFID) tags, comprising:
emitting out an omni-directional radio frequency signal to omni-directionally scan the RFID tags;
emitting a radio frequency signal composed of P beams directed to P specific directions, wherein P is an integer larger than or equal to 1;
performing a spatial matched filter processing directed to the specific directions, so as to read the RFID tags in the specific directions; and
adjusting angles of the specific directions, and repeating the above two steps, till all the directions have been scanned.

2. The method for reading RFID tags as claimed in claim 1, further comprising:
changing the number of P, and repeating all the other steps except emitting out an omni-directional radio frequency signal, so as to repeatedly read the RFID tags in all the directions.

3. The method for reading RFID tags as claimed in claim 2, wherein P is adjusted to be equal to 4 or 2, so as to read the RFID tags in all the directions, and when P is equal to 4, the difference between each of the specific directions is 90 degrees, so that the reading apparatus must emit a radio frequency signal composed of 4 beams twice; when P is equal to 2, the difference between each of the specific directions is 180 degrees, so that the reading apparatus must emit a radio frequency signal composed of 2 beams for 4 times.

4. The method for reading RFID tags as claimed in claim 3, wherein P is further adjusted to be equal to 1, so that the reading apparatus must emit a radio frequency signal composed of 1 beam for 8 times, so as to read the RFID tags in all the directions.

5. The method for reading RFID tags as claimed in claim 1, wherein when P is equal to 4, the difference between each of the specific directions is 90 degrees, so that the reading apparatus must emit a radio frequency signal composed of 4 beams twice, so as to read the RFID tags in all the directions.

6. The method for reading RFID tags as claimed in claim 5, further comprising:
changing the number of P, and repeating all the other steps except emitting out an omni-directional radio frequency signal, so as to read the RFID tags in all the directions, wherein P is adjusted to be equal to 1, the reading apparatus must emit a radio frequency signal composed of 1 beam for 8 times, so as to read the RFID tags in all the directions.

7. The method for reading RFID tags as claimed in claim 1, wherein when P is equal to 2, the difference between each of the specific directions is 180 degrees, so that the reading apparatus must emit a radio frequency signal composed of 2 beams for 4 times, so as to read the RFID tags in all the directions.

8. The method for reading RFID tags as claimed in claim 7, further comprising:
changing the number of P, and repeating all the other steps except emitting out an omni-directional radio frequency signal, so as to repeatedly read the RFID tags in all the directions, wherein P is adjusted to be equal to 1, the reading apparatus must emit a radio frequency signal composed of 1 beam for 8 times, so as to read the RFID tags in all the directions.

9. The method for reading RFID tags as claimed in claim 1, applicable for a reading apparatus, wherein the reading apparatus comprises a plurality of antenna and a plurality of weight control units corresponding to the antennas one by one, and the weight control units are used for adjusting weights of the corresponding antennas, so as to emit beams or perform a spatial matched filter processing in the specific directions.

10. An apparatus for reading RFID tags, comprising:
an antenna array, having a plurality of antennas; and
a beam synthesis unit, having a plurality of weight control units coupled to the corresponding antennas one by one, for adjusting a weight vector of the antenna array, so as to form a beam or a null in a predetermined direction, wherein the reading apparatus emits out an omni-directional radio frequency signal to omni-directionally scan the RFID tags; the reading apparatus emits a radio frequency signal composed of P beams directed to P specific directions, and a spatial matched filter processing is performed directed to the specific directions, so as to read the RFID tags in the specific directions, wherein P is an integer larger than or equal to 1.

11. The apparatus for reading RFID tags as claimed in claim 10, wherein the reading apparatus adjusts angles of the specific directions, and repeats the steps of emitting a radio frequency signal composed of P beams directed to P new specific directions, and a spatial matched filter processing is performed directed to the new specific directions, so as to read the RFID tags in the new specific directions, till all the directions have been scanned.

12. The apparatus for reading RFID tags as claimed in claim 11, wherein the reading apparatus changes the number of P, repeats the step of emitting a radio frequency signal composed of P beams directed to P specific directions, and a spatial matched filter processing is performed directed to the specific directions, so as to read the RFID tags in the specific directions; the reading apparatus further adjusts angles of the specific directions, repeats the step of emitting a radio frequency signal composed of P beams directed to P new specific directions, and the spatial matched filter processing is performed directed to the new specific directions, so as to read the RFID tags in the new specific directions, till all the directions have been scanned, and thus repeatedly reading the RFID tags in all the directions.

13. The apparatus for reading RFID tags as claimed in claim 12, wherein the reading apparatus is adjusted to be equal to 4 or 2, and when P is equal to 4, the difference between each of the specific directions is 90 degrees, so that the reading apparatus must emit a radio frequency signal composed of 4 beams twice, so as to read the RFID tags in all the directions; when P is equal to 2, the difference between each of the specific directions is 180 degrees, so that the reading apparatus must emit a radio frequency signal composed of 2 beams for 4 times, so as to read the RFID tags in all the directions.

14. The apparatus for reading RFID tags as claimed in claim 13, wherein when the reading apparatus is adjusted to be equal to 1, the reading apparatus must emit a radio frequency signal composed of 1 beam for 8 times, so as to read the RFID tags in all the directions.

15. The apparatus for reading RFID tags as claimed in claim 12, wherein the reading apparatus adjusts P to be equal to 4 or 1, when P is equal to 4, the difference between each of the specific directions is 90 degrees, so that the reading apparatus must emit a radio frequency signal composed of 4 beams twice, so as to read the RFID tags in all the directions; when P is equal to 1, the reading apparatus must emit a radio frequency signal composed of 1 beam for 8 times, so as to read the RFID tags in all the directions.

16. The apparatus for reading RFID tags as claimed in claim 12, wherein the reading apparatus adjusts P to be equal to 2 and 1, when P is equal to 2, the difference between each of the specific directions is 180 degrees, and the reading apparatus must emit a radio frequency signal composed of 2 beams for 4 times, so as to read the RFID tags in all the directions; when P is equal to 1, the reading apparatus must emit a radio frequency signal composed of 1 beam for 8 times, so as to read the RFID tags in all the directions.

17. The apparatus for reading RFID tags as claimed in claim 11, wherein P is equal to 4, the difference between each of the specific directions is 90 degrees, and the reading apparatus must emit a radio frequency signal composed of 4 beams twice, so as to read the RFID tags in all the directions.

18. The apparatus for reading RFID tags as claimed in claim 11, wherein P is equal to 2, the difference between each of the specific directions is 180 degrees, and the reading apparatus must emit a radio frequency signal composed of 2 beams for 4 times, so as to read the RFID tags in all the directions.

19. The apparatus for reading RFID tags as claimed in claim 11, wherein P is equal to 1, the reading apparatus must emit a radio frequency signal composed of 1 beam for 8 times, so as to read the RFID tags in all the directions.

20. The apparatus for reading RFID tags as claimed in claim 10, wherein the power of the omni-directional radio frequency signal is equal to that of the radio frequency signal composed of P beams.
